(19) United States
(12) Patent Application Publication
(10) Pub. No.: US 2016/0156211 A1
(43) Pub. Date: Jun. 2, 2016

(54) BATTERY CHARGING METHOD AND BATTERY PACK USING THE SAME

(71) Applicant: SAMSUNG SDI CO., LTD., Yongin-si (KR)

(72) Inventors: K. V. SUNDARAAMAN, Yongin-si (KR); Ji-Hwan SEOL, Yongin-si (KR); Jeong-Guk BAE, Yongin-si (KR)

(21) Appl. No.: 14/945,748

(22) Filed: Nov. 19, 2015

(30) Foreign Application Priority Data
Nov. 27, 2014 (KR) 10-2014-0167452

(51) Int. Cl. H02J 7/00

(52) U.S. Cl. CPC H02J 7/0052; H02J 7/0021; H02J 7/0045; H02J 2007/0059

(57) ABSTRACT

A battery pack includes a plurality of battery cells and a charger to charge the battery cells. The charger charges the battery cells a first time to a first predetermined voltage based on power from an external power source and charges a portion of the battery cells a second time to a second predetermined voltage.

### CROSS-REFERENCE TO RELATED APPLICATION

Korean Patent Application No. 10-2014-0167452, filed on Nov. 27, 2014, and entitled: “Battery Charging Method and Battery Pack Using The Same,” is incorporated by reference herein in its entirety.

### BACKGROUND

1. Field

One or more embodiments described herein relate to a method for charging a battery and a battery pack using the same.

2. Description of the Related Art

Mobile phones, digital cameras, notebook computers, and other portable electronic devices are in wide use and operate based on battery power. Efforts are being undertaken to develop large-capacity battery systems for electric vehicles, Uninterruptible Power Supplies, and energy storing systems.

### SUMMARY

In accordance with one or more embodiments, a battery pack includes a plurality of battery cells; and a charger to charge the battery cells, wherein the charger is to charge the battery cells a first time to a first predetermined voltage based on power from an external power source and is to charge a portion of the battery cells a second time to a second predetermined voltage. The charger may include a DC-DC converter to charge the battery cells, except the portion of the battery cells, to the second predetermined voltage. The DC-DC converter may convert the external power source and may apply the converted external power to charge the battery cells, except the portion of the battery cells, to the second predetermined voltage, the second predetermined voltage may be equal to or larger than a maximum charge capacity of each of the battery cells.

The charger may apply the external power source to a positive terminal and a negative terminal of a battery unit including the battery cells, or the external power source to the portion of the battery cells. The charger may include a terminal to which the external power source is applied; a charging/discharging circuit connected to the terminal, the charging/discharging circuit to transmit the external power source to the battery cells based on a gate signal; a microcomputer to output control signals for a charging operation; a gate driver to output the gate signal based on the control signal; and an analog front end connected to the battery cells, the analog front end to monitor at least one of a voltage or a temperature of the battery cells. The second predetermined voltage may be maximum charge capacity of each of the battery cells.

In accordance with one or more other embodiments, a battery pack includes a battery unit including a plurality of battery cells; a switch circuit to apply an external power source to a positive terminal and a negative terminal of the battery unit to charge the battery cells to a first predetermined voltage, and to charge a portion of the battery cells to a second predetermined voltage based on the external power source; and a DC-DC converter to charge the battery cells, except the portion of the battery cells, to second predetermined voltage.

The DC-DC converter may convert the external power source and to output the converted voltage to charge the battery cells, except the portion of the battery cells, to the second predetermined voltage, the second predetermined voltage may be equal to or larger than a maximum charge capacity of each of the battery cells.

The switch circuit may charge the battery cells to the first predetermined voltage based on the external power source applied to the positive terminal and the negative terminal of the battery unit, and may charge the portion of battery cells to the second predetermined voltage based on the external power source. The second predetermined voltage may correspond to a maximum charge capacity of each of the battery cells.

In accordance with one or more other embodiments, a method for charging a battery pack includes charging a plurality of battery cells to a first voltage level based on power from an external power source; and charging a first number of the battery cells to a second voltage level based on power from the external power source, wherein the first voltage level is lower than a maximum charge voltage of each of the battery cells and wherein the second voltage level is greater than the first voltage level.

The method may include charging a second number of the battery cells to the second voltage level based on a converted voltage derived from the external power source, wherein the second number of battery cells is charged to the second voltage level after the first number of battery cells is charged to the second voltage level. The second voltage level may correspond to a maximum charge voltage of each of the battery cells.

In accordance with another embodiment, a charger includes a connector to connect the charger to a battery; and a controller, connected to the battery through the connector, to perform a first charging operation and a second charging operation, the first charging operation to charge a plurality of battery cells of the battery to a first voltage level and the second charging operation to charge a first number of the battery cells to a second voltage level greater than the first voltage level, wherein the first number of battery cells is less than all of the battery cells.

The controller may perform a third charging operation which includes charging a second number of the battery cells based on power from a converter circuit. The controller may connect the battery cells to an external power source during the first charging operation, and is to output power to the first number of battery cells during the second charging operation based on power from the external power source. The first number of battery cells may not include any of the second number of battery cells. The first number may be different from the second number. The third charging operation may include charging the second number of the battery cells to the second voltage level. The second voltage level may correspond to a maximum charge capacity of each of the battery cells.

### BRIEF DESCRIPTION OF THE DRAWINGS

Features will become apparent to those of skill in the art by describing in detail exemplary embodiments with reference to the attached drawings in which:

FIG. 1 illustrates an embodiment of a battery pack; and

FIG. 2 illustrates an embodiment of a method for charging a battery pack;

FIG. 3 illustrates another embodiment of a battery pack; and

FIG. 4 illustrates another embodiment of a method for charging a battery pack.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art Like reference numerals refer to like elements throughout. Embodiments may be combined to form additional embodiments.

Throughout this specification and the claims that follow, when it is described that an element is “coupled” to another element, the element may be “directly coupled” to the other element or “electrically coupled” to the other element through a third element. Throughout the specification and the claims, unless explicitly described to the contrary, the word “comprise” and variations such as “comprises” or “comprising” will be understood to imply the inclusion of stated elements but not the exclusion of any other elements.

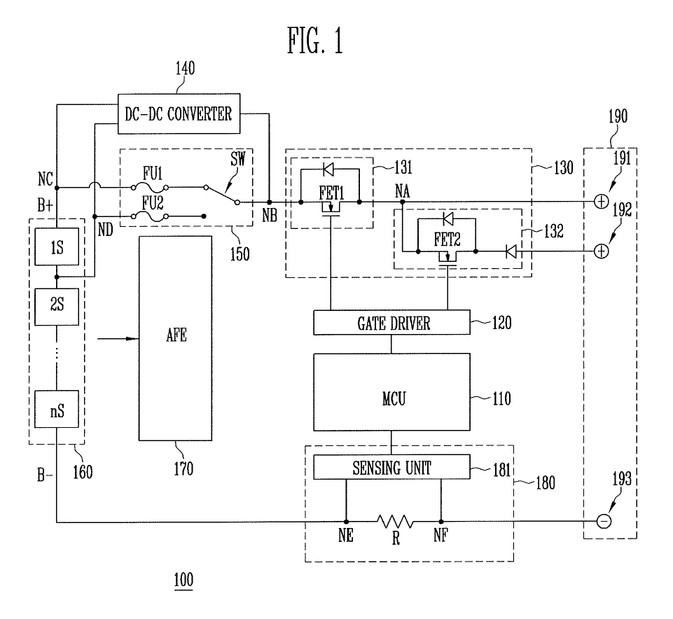

FIG. 1 illustrates an embodiment of a battery pack 100 which includes a Micro Computer (MCU) 110, a gate driver 120, a charging/discharging circuit 130, a DC-DC converter 140, a switch unit 150, a battery unit 160, an analog front end (AFE) 170, a current measuring unit 180, and a terminal unit 190. Except for the battery unit 160, the MCU 110, the gate driver 120, the charging/discharging circuit 130, the DC-DC converter 140, the switch unit 150, the AFE 170, the current measuring unit 180, and the terminal unit 190 may be defined as a charging circuit.

The MCU 110 performs functions such as charging/discharging control of the battery unit 160 and balancing control of battery cells in the battery unit 160. Further, the MCU 110 monitors a State Of Charge (SOC) of the battery unit 160 corresponding to a current from the current measuring unit 180.

The gate driver 120 outputs gate signals for operating the charging/discharging circuit 130 based on control signals from the MCU 110 during a charging/discharging operation.

The charging/discharging circuit 130 includes a charge switch 131 and a discharge switch 132. The charge switch 131 is connected between a node NA and a node NB. The node NA is connected to a charge terminal 191 of the terminal unit 190, and the node NB is connected with the DC-DC converter 140. The charge switch 131 electrically connects nodes NA and NB, based on a gate signal from the gate driver 120 during the charging operation, to form a current path. The charge switch 131 may include, for example, a field effect transistor FET1.

The discharge switch 132 is connected between a discharge terminal 192 of the terminal unit 190 and the node NA. The discharge switch 132 electrically connects the node NA and the discharge terminal 192 based on a gate signal from the gate driver 120 during the discharging operation to form a current path. The discharge switch 132 may include. for example, a field effect transistor FET2.

The DC-DC converter 140 is connected between the node NB and the battery unit 160. The DC-DC converter 140 converts a high voltage (for example, 57 V) input through the charging switch 131 to a low voltage (for example, 4.2 V) and outputs the converted voltage to the battery unit 160 during the charging operation. The converted voltage, for example, may be equal to or larger than a maximum charge voltage Vmax of each of the plurality of battery cells in the battery unit 160.

The switch unit 150 electrically connects the nodes NB and NC based on one setting of switch unit 150. The node NC is connected to a top cell 1S of the battery unit 160. The switch unit 150 electrically connects the nodes NB and ND based on another setting of switch unit 150. The node ND is between the top cell 1S of the battery unit 160 and the second battery cell 2S.

For example, during a charging operation, the switch unit 150 electrically connects the node NB and the top cell 1S of the battery unit 160 in order to charge all of the battery cells 1S to nS of the battery unit 160 using a high voltage (for example, 57 V) input through the charge switch 131. The switch unit 150 may also electrically connect the node NB and a space between the top cell 1S and the second battery cell 2S to charge the remaining battery cells 2S to nS, except for the top cell 1S, using a high voltage (for example, 57 V) input through the charge switch 131.

The switch unit 150 includes a switching element SW and fuses FU1 and FU2. The switching element SW electrically connects a fuse FU1 connected to the nodes NC and NB or electrically connects a fuse FU2 connected to the nodes ND and NB.

The battery unit 160 supplies stored power to an electronic device coupled to the battery pack 100. When a charger is connected to the battery pack 100, the battery unit 160 is charged by external current input through the terminal unit 190. The battery unit 160 includes one or more battery cells 1S to nS. The one or more battery cells 1S to nS may be serially connected to a positive terminal (B+) and a negative terminal (B−) of the battery unit 160. Each of the battery cells 1S to nS may be a rechargeable secondary battery, e.g., a nickel-cadmium battery, a lead storage battery, a nickel metal hydride (NiMH) battery, a lithium ion battery, a lithium polymer battery, or a combination of these batteries.

The AFE 170 is connected to the battery unit 160 and monitors information corresponding the battery cells 1S to nS in the battery unit 160. For example, the AFE 170 measures data obtained by monitoring a voltage, a temperature, and/or another parameter of each of the battery cells 1S to nS in order to determine whether a problem or abnormality has occurred during the charging/discharging operation.

The current measuring unit 180 measures an SOC of the battery unit 160 through a node NE connected to the negative terminal B− of the battery unit 160. The current measuring unit 180 includes a resistor R connected to the negative terminal B− of the battery unit 160 and a sensing unit 181 connected to ends NE and NF of the resistor R. The sensing unit 181 measures a current amount flowing through the resistor R, measures an SOC of the battery unit 160, and outputs measured data to the MCU 110.

The terminal unit 190 connects the battery pack 100 and an external device. The external device may be, for example, an electronic device, a vehicle, an electric vehicle, or a charger. The terminal unit 190 includes the positive terminal 191, the discharge terminal 192, and a negative terminal 193, and may further include a communication terminal for inputting data from the MCU 110. The positive terminal 191 and the discharge terminal 192 may be configured as one terminal, or the discharge terminal 192 and the negative terminal 193 may be configured as one terminal. During the charging operation, the terminal unit 190 may perform charging based a connection of the positive terminal 191 and the negative terminal 193.

One proposed method for charging the battery 100 unit involves charging battery cells 1S to 14S to a voltage of about 4.07 V based on a charge voltage (e.g., 57V) applied from an external device. As a result, each of the battery cells 1S to 14S are intended to be placed in a charged state of, for example, about 97%. However, actually, each battery cell may be charged to a lower state (e.g., about 90%) as a result of a leakage current and a discharging operation.

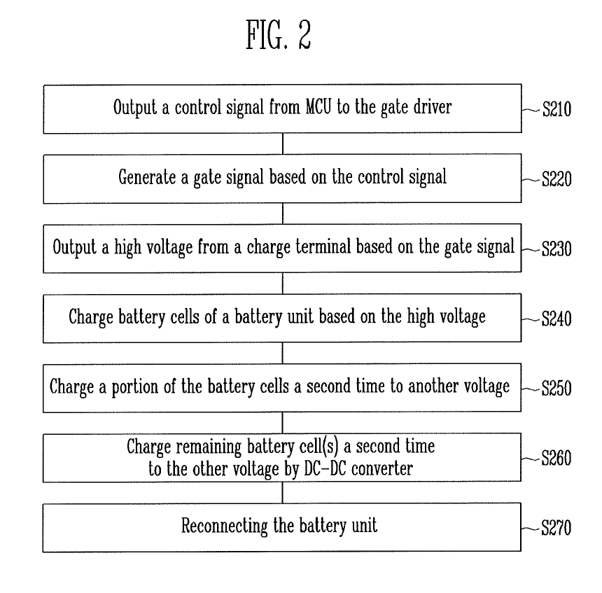

FIG. 2 illustrates an embodiment of an improved method for performing a charging operation of the battery pack 100. In this embodiment, it is assumed that the battery unit 160 includes 14 battery cells 1S to 14S, a maximum SOC of each battery cell is 4.2 V, and a charge voltage applied from an external device is a maximum of 57 V. In another embodiment, the method may be applied to a battery pack having a different number of battery cells, a different maximum SOC, and/or a different maximum charging voltage.

Referring to FIG. 2, the method includes outputting a control signal from the MCU 110 during a charging operation of the battery unit 160 (operation S210). The control signal is output to the gate driver 120 for purposes of generating a gate signal (operation S220). The gate signal controls the charge switch 131 to outputs a high voltage (e.g., 57V) from charge terminal 191 to the switch unit 150 (operation S230).

The switch unit 150 performs a switching operation to connect the node NB and the positive terminal B+ of the battery unit 160. A ground or other reference voltage is applied to the negative terminal B− of the battery unit 160 through the negative terminal 193. Accordingly, each of the battery cells 1S to 14S of the battery unit 160 is first charged to a voltage of about 4.07 V (operation S240).

Then, the switching unit 150 performs a switching operation to block the connection of the node NB and the positive terminal B+ of the battery unit 160, and connects (e.g., simultaneously connects) the nodes NB and ND. The node ND is between the top cell 1S and the second battery cell 2S of the battery unit 160. Accordingly, the battery cells 2S to 14S are charged a second time with 4.2 V, which is a maximum SOC, by the high voltage (57 V) input through the charge terminal 191 (operation S250).

The DC-DC converter 140 converts the high voltage (57 V) applied through the node NB to the low voltage (4.2 V), and applies the converted voltage to the top cell 1S of the battery unit 160. Accordingly, the top cell 1S, having a charge of about 4.07 V, is charged a second time up to 4.2 V (operation S260). Accordingly, all of the battery cells 1S to 14S are charged to 4.2 V, which is the maximum SOC of each of the battery cells.

Then, the switch unit 150 performs a switching operation to block the connection between the nodes NB and ND and to connect (e.g., simultaneously connects) the node NB and the positive terminal B+ of the battery unit 160 again (operation S270). The switch unit 150 may perform rapid switching operations. e.g., with a period of Ins to 9 ns. This is because, if the switching operation is performed slowly, there is a chance that the charge terminal 192 may determine that the charge voltage is low, and thus may stop the charging operation.

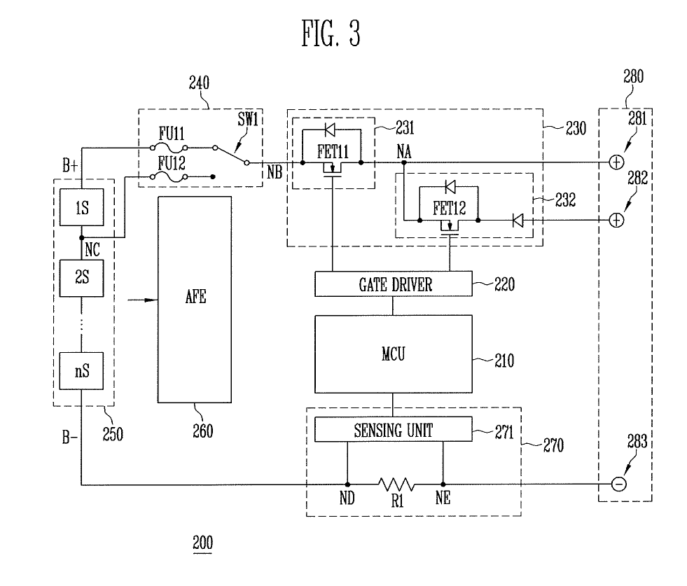

FIG. 3 illustrates another embodiment of a battery pack 200. Referring to FIG. 2, the battery pack 200 includes a Micro Computer (MCU) 210, a gate driver 220, a charging/discharging circuit 230, a DC-DC converter 240, a switch unit 150, a battery unit 250, an analog front end (AFE) 260, a current measuring unit 270, and a terminal unit 280.

Except for the battery unit 250, the MCU 210, the gate driver 220, the charging/discharging circuit 230, the DC-DC converter 240, the switch unit 150, the AFE 260, the current measuring unit 270, and the terminal unit 280 may be corresponding to a charging circuit.

The MCU 210 performs functions such as charging/discharging control of the battery unit 250 and balancing control of battery cells in the battery unit 250. Further, the MCU 210 monitors a State Of Charge (SOC) of the battery unit 250 corresponding to a current from the current measuring unit 270.

The gate driver 220 outputs gate signals for operating the charging/discharging circuit 230 based on control signals from the MCU 210 during a charging/discharging operation.

The charging/discharging circuit 230 includes a charge switch 231 and a discharge switch 232. The charge switch 231 is connected between a node NA connected to a charge terminal 281 of the terminal unit 280 and a node NB connected to the switch unit 240. The charge switch 231 electrically connects the nodes NA and NB based on a gate signal from the gate driver 220 during a charging operation in order to form a current path. The charge switch 231 include, for example, a field effect transistor FET11.

The discharge switch 232 is connected between a discharge terminal 282 of the terminal unit 280 and the node NA. The discharge switch 232 electrically connects the node NA and the discharge terminal 292 based on a gate signal output from the gate driver 220 during a discharging operation to form a current path. The discharge switch 232 may include, for example, a field effect transistor FET12.

The switch unit 240 electrically connects the node NB and a positive terminal B+ of the battery unit 250, or electrically connects the nodes NB and NC between a top cell 1S and the second battery cell 2S of the battery unit 250. For example, the switch unit 240 electrically connects the node NB and the positive terminal B+ of the battery unit 250 to charge all of the battery cells 1S to nS of the battery unit 250 based on a high voltage (for example, 57 V) input through the charge switch 231. The switch 240 may also electrically connect the node NB and a space between the top cell 1S and the second battery cell 2S to charge remaining battery cells 2S to nS, except for the top cell 1S, based on a high voltage (for example, 57 V) input through the charge switch 131.

The switch unit 240 includes a switching element SW1 and fuses FU11 and FU12. The switching element SW1 electrically connects the fuse FU11 and a node NB based on a first setting of switch unit 240. The fuse FU11 is connected to the positive terminal B+ of the battery unit 250. The switch unit 240 connects the fuse FU12 to the node NB based on another setting of switch 240. The fuse FU12 is connected to the node NC between battery cells 1S and 2S.

The battery unit 250 supplies stored power to an electronic device coupled to the battery pack 200. When a charger is connected to the battery pack 200, the battery unit 250 is charged by an external current input through the terminal unit 280. The battery unit 250 includes one or more battery cells 1S to nS. One or more battery cells 1S to nS may be serially connected to the positive terminal (B+) and a negative terminal (B−) of the battery unit 250. Each of the battery cells 1S to nS may be a rechargeable secondary battery. Examples include a nickel-cadmium battery, a lead storage battery, a nickel metal hydride (NiMH) battery, a lithium ion battery, a lithium polymer battery, or a combination of these batteries.

The AFE 260 monitors information corresponding to each of the battery cells 1S to nS in the battery unit 250. For example, the AFE 170 measures data obtained by monitoring a voltage, a temperature, or another parameter of each of the battery cells 1S to nS to determining whether a problem or abnormality has occurred during the charging/discharging operation.

The current measuring unit 270 measures an SOC of the battery unit 250 through a node ND connected with the negative terminal B− of the battery unit 250. The current measuring unit 270 includes a resistor R1 connected to negative terminal B− of the battery unit 250, and a sensing unit 271 connected to ends NE and NF of the resistor R1. The sensing unit 271 measures a current amount flowing through the resistor R1, measures an SOC of the battery unit 250, and outputs measured data to the MCU 210.

The terminal unit 280 connects the battery pack 200 and an external device. The external device may be, for example, an electronic device, a vehicle, an electric vehicle, or a charger. The terminal unit 280 includes the positive terminal 281, the discharge terminal 282, and a negative terminal 283. The terminal unit 280 may also include a communication terminal for inputting data from the MCU 210. Further, the positive terminal 281 and the discharge terminal 282 may be configured as one terminal, or the discharge terminal 282 and the negative terminal 283 may be configured as one terminal. During the charging operation, the terminal unit 280 performs charging based on a connection of the positive terminal 281 and the negative terminal 283.

One proposed charging method applied to the battery pack 200 involves charging each of the battery cells 1S to 14S to a voltage of about 4.07 V based on a charge voltage (e.g., 57V) applied from an external device. As a result, each of battery cells 1S to 14S is intended to be charged to a state of about 97%. Actually, each battery cell may be charged to a state of about 90% based on leakage current and a discharging operation.

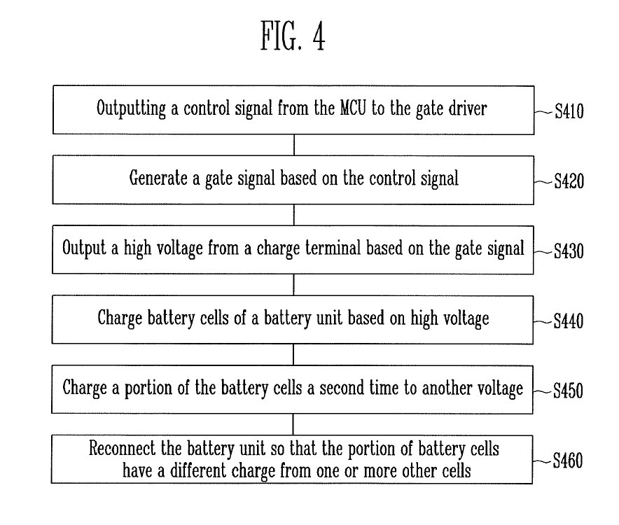

FIG. 4 illustrates another embodiment of an improved method for performing a charging operation of the battery pack 200. In this embodiment, it is assumed the battery unit 250 includes 14 battery cells 1S to 14S, a maximum SOC of each battery cell is 4.2 V, and a charge voltage applied from an external device is a maximum of 57 V. In another embodiment, a different number of battery cells, a different maximum SOC, and/or a different maximum charge voltage may be used.

Referring to FIG. 4, the method includes outputting a control signal from the MCU 210 to the gate driver during a charging operation of the battery unit 250 (operation S410). The gate driver 220 outputs a gate signal based on the control signal (operation S420). The gate signal is input into the charge switch 231, and the charge switch outputs a high voltage (e.g., 57V) from the charge terminal 281 to the positive terminal B+ of the battery unit 150 based on the gate signal (operation S430). In this case, a ground or other reference voltage is applied to the negative terminal B− of the battery unit 160 through the negative terminal 283 of the terminal unit 280. Accordingly, each of the battery cells 1S to 14S of the battery unit 250 is charged a first time to a voltage of about 4.07 V (operation S440).

Then, the switching unit 150 performs a switching operation to block the connection of the node NB and the positive terminal B+ of the battery unit 250 and to connect (e.g., simultaneously connects) the nodes NB and NC. The node NC is between the top cell 1S and the second battery cell 2S of the battery unit 250. As a result, the battery cells 2S to 14S are charged a second time to 4.2 V, which is a maximum SOC, by the high voltage (57 V) input through the charge terminal 281 (operation S450).

Then, the switch unit 240 performs a switching operation to block the connection between the nodes NB and NC and to connect (e.g., simultaneously connect) the node NB and the positive terminal B+ of the battery unit 250 again. Accordingly, battery cells 2S to 14C retain a charge of up to 4.2 V, which is the maximum SOC, and only the top cell 1S is charged to 4.07 V. Further, the charge voltage of the battery cells 2S to 14S is larger than the charge voltage of the top cell 1S (operation S460). As a result, some current of the battery cells 2S to 14S are applied to the top cell 1S, so that the charge voltages are averaged.

The MCU and other control features of the embodiments described herein may be implemented in logic which, for example, may include hardware, software, or both. When implemented at least partially in hardware, the MCU and other control features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the MCU and other control features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

In some of the aforementioned, the top cell 1S of the battery cells is charged separately from the remaining cells. In another embodiment, more than one battery cell may be charged separately from the remaining cells. In this case, the node ND may be connected, for example, between adjacent battery cells other than cells 1S and 2S.

In accordance with one embodiment, a charger includes a connector to connect the charger to a battery; and a controller, connected to the battery through the connector, to perform a first charging operation and a second charging operation, the first charging operation to charge a plurality of battery cells of the battery to a first voltage level and the second charging operation to charge a first number of the battery cells to a second voltage level greater than the first voltage level, wherein the first number of battery cells is less than all of the battery cells. In this embodiment, the connector may correspond to an interface between the positive and negative terminals B+ and B− of the battery unit, or may correspond to another interface between the battery unit and the external power source.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A battery pack, comprising:
a plurality of battery cells; and
a charger to charge the battery cells, wherein the charger is to charge the battery cells a first time to a first predetermined voltage based on power from an external power source and is to charge a portion of the battery cells a second time to a second predetermined voltage.

2. The battery pack as claimed in claim 1, wherein the charger includes:
a DC-DC converter to charge the battery cells, except the portion of the battery cells, to the second predetermined voltage.

3. The battery pack as claimed in claim 2, wherein the DC-DC converter is to convert the external power source and to apply the converted external power to charge the battery cells, except the portion of the battery cells, to the second predetermined voltage, the second predetermined voltage equal to or larger than a maximum charge capacity of each of the battery cells.

4. The battery pack as claimed in claim 1, wherein the charger is to apply:
the external power source to a positive terminal and a negative terminal of a battery unit including the battery cells, or
the external power source to the portion of the battery cells.

5. The battery pack as claimed in claim 1, wherein the charger includes:
a terminal to which the external power source is applied;
a charging/discharging circuit connected to the terminal, the charging/discharging circuit to transmit the external power source to the battery cells based on a gate signal;
a microcomputer to output control signals for a charging operation;
a gate driver to output the gate signal based on the control signal; and
an analog front end connected to the battery cells, the analog front end to monitor at least one of a voltage or a temperature of the battery cells.

6. The battery pack as claimed in claim 1, wherein the second predetermined voltage is maximum charge capacity of each of the battery cells.

7. A battery pack, comprising:
a battery unit including a plurality of battery cells;
a switch circuit to apply an external power source to a positive terminal and a negative terminal of the battery unit to charge the battery cells to a first predetermined voltage, and to charge a portion of the battery cells to a second predetermined voltage based on the external power source; and
a DC-DC converter to charge the battery cells, except the portion of the battery cells, to the second predetermined voltage.

8. The battery pack as claimed in claim 7, wherein the DC-DC converter is to convert the external power source and to output the converted voltage to charge the battery cells, except the portion of the battery cells, to the second predetermined voltage, the second predetermined voltage equal to or larger than a maximum charge capacity of each of the battery cells.

9. The battery pack as claimed in claim 7, wherein the switch circuit is to charge the battery cells to the first predetermined voltage based on the external power source applied to the positive terminal and the negative terminal of the battery unit, and is to charge the portion of battery cells to the second predetermined voltage based on the external power source.

10. The battery pack as claimed in claim 7, wherein the second predetermined voltage corresponds to a maximum charge capacity of each of the battery cells.

11. A method of charging a battery pack, comprising:
charging a plurality of battery cells to a first voltage level based on power from an external power source; and
charging a first number of the battery cells to a second voltage level based on power from the external power source, wherein the first voltage level is lower than a maximum charge voltage of each of the battery cells and wherein the second voltage level is greater than the first voltage level.

12. The method as claimed in claim 11, further comprising:
charging a second number of the battery cells to the second voltage level based on a converted voltage derived from the external power source, wherein the second number of battery cells is charged to the second voltage level after the first number of battery cells is charged to the second voltage level.

13. The method as claimed in claim 11, wherein the second voltage level corresponds to a maximum charge voltage of each of the battery cells.

14. A charger, comprising:
a connector to connect the charger to a battery; and
a controller, connected to the battery through the connector, to perform a first charging operation and a second charging operation, the first charging operation to charge a plurality of battery cells of the battery to a first voltage level and the second charging operation to charge a first number of the battery cells to a second voltage level greater than the first voltage level, wherein the first number of battery cells is less than all of the battery cells.

15. The charger as claimed in claim 14, wherein the controller is to perform a third charging operation which includes charging a second number of the battery cells based on power from a converter circuit.

16. The charger as claimed in claim 15, wherein the controller is to connect the battery cells to an external power source during the first charging operation, and is to output power to the first number of battery cells during the second charging operation based on power from the external power source.

17. The charger as claimed in claim 15, wherein the first number of battery cells does not include any of the second number of battery cells.

18. The charger as claimed in claim 15, wherein the first number is different from the second number.

19. The charger as claimed in claim 15, wherein the third charging operation includes charging the second number of the battery cells to the second voltage level.

20. The charger as claimed in claim 14, wherein the second voltage level corresponds to a maximum charge capacity of each of the battery cells.
